(19) United States
(12) Patent Application Publication
(10) Pub. No.: US 2011/0286227 A1
(43) Pub. Date: Nov. 24, 2011

(54) LED LAMP, MOUNTING AND METHOD FOR OPERATING AN LED LAMP

(75) Inventors: Harald Dellian, Edling (DE); Markus Hofmann, Bad Abbach (DE)

(73) Assignee: OSRAM GESELLSCHAFT MIT BESCHRAENKTER HAFTUNG, Muenchen (DE)

(21) Appl. No.: 13/146,684

(22) PCT Filed: Jan. 12, 2010
(86) PCT No.: PCT/EP2010/050270

§ 371 Date: Jul. 28, 2011

(30) Foreign Application Priority Data
Jan. 28, 2009 (DE) 10 2009 006 420.6

(51) Int. Cl. F21S 8/00

(52) U.S. Cl. 362/430

(57) ABSTRACT

A lamp may include illumination means which include at least one LED, and having a base, by way of which the lamp can be connected to a mounting in order to be supplied with voltage, wherein the illumination means are connected to the base by way of a mechanism which in a first state couples the illumination means in rotatable fashion to the base around an axis and in a second state couples the illumination means to the base in a rotatably fixed manner, and light emitted by the illumination means has an intensity distribution which is asymmetric with respect to the axis.

### TECHNICAL FIELD

The invention relates to an LED lamp (LED—light emitting diode) in accordance with the preamble of claim 1 and also a mounting for a lamp and a method for operating an LED lamp.

### PRIOR ART

LED lamps have the major economic advantage that in comparison with conventional filament lamps or also with compact fluorescent lamps they only require a fraction of the electrical energy in order to generate light having the same brightness as the conventional incandescent lamps. However, the emission characteristic of the LEDs is restricted, as a result of the technical design. In other words, the light emitted by LED lamps is relatively strongly focused. In this situation, LED lamps typically emit their light in conical light beams. The light thus has an intensity sufficient for an illumination purpose only in a relatively small solid angle. Another designation for lamps of this type is also spot light. In order to increase this emission angle, there are also LED lamps which achieve an emission angle of up to 100° by means of lens units.

In contrast to LED lamps, conventional filament lamps or compact fluorescent lamps have an almost omnidirectional emission characteristic in respect of the light, in other words they emit their light with the same intensity in almost every spatial direction. Many light fittings which are used today in domestic households, ceiling light fittings or table lamps for example, are designed for filament lamps or compact fluorescent lamps, in other words for lamps having an omnidirectional emission characteristic. For the purpose of energy saving, such light fittings can however also be equipped with an LED lamp. In the applicant's company, the corresponding product is known as an LED RETROFIT lamp. Such LED lamps which are used in light fittings for lamps having an omnidirectional emission characteristic have the disadvantage that a smaller spatial area is then illuminated than was previously possible with the same light fitting and a conventional filament lamp or compact fluorescent lamp. In this situation, the light beam of the LED lamp is emitted in particular in a direction predetermined by the mounting of the light fitting. With regard to ceiling light fittings, this is often vertically downwards, which means that the walls of a room are inadequately illuminated.

### STATEMENT OF THE INVENTION

The object of the present invention is to provide facilities to allow an LED lamp to be used in a more flexible manner in a light fitting for lamps having an omnidirectional emission characteristic.

This object is achieved by a lamp according to claim 1. The object is also achieved by a lamp according to claim 4. The object is furthermore achieved according to the invention by a mounting according to claim 7. Together, these lamps and the mounting enable a method according to claim 8 to be carried out for operating a lamp. Advantageous developments of the invention are set down in the subclaims.

A first solution for the object of the invention given by the invention augments a lamp in accordance with the preamble of claim 1 in such a manner that with regard to the lamp according to the invention, LED illumination means of the lamp are connected to a base of the lamp by way of a mechanism which in a first state couples the illumination means to the base such as to be rotatable around an axis and in a second state couples the illumination means to the base in a rotatably fixed manner. Furthermore, according to the invention the illumination means have an intensity distribution for the emitted light which is asymmetric with respect to the axis around which the illumination means can be rotated.

The intensity distribution of illumination means can be ascertained for example by using a light sensor to sense the intensity of the light emitted by the illumination means at a constant distance from the lamp for different spatial directions. In this situation, all those spatial directions for which the intensity sensed exceeds a predetermined value are jointly referred to as the so-called illumination cone of the lamp. Contrary to the designation “cone”, an illumination cone in the present instance is not however necessarily understood to be a spatial segment which is rotationally symmetrical.

According to the invention, the illumination means of the lamp can be rotated around an axis, whereby an illumination cone produced by the illumination means is formed asymmetrically with respect to this axis or a symmetrical illumination cone is orientated obliquely to the axis. If the illumination means are now rotated around the axis, then the illumination cone of the lamp can thereby be pivoted in a space and directed onto objects which are preferably to be illuminated. By means of the invention it is therefore possible to orientate the illumination cone of the LED lamp even in the case of such light fittings as cannot be pivoted because for example they are designed for omnidirectionally emitting lamps.

A further advantage results in that additional space is available in the interior of the mechanism providing the rotation facility, in which space are accommodated electronic components of the lamp.

The mechanism for rotating the illumination means can preferably be transferred from the first state in which it connects the illumination means to the base in rotatable fashion into the second state by pushing or pulling a part of the mechanism. It is thereby also possible to mount a pivotable illumination means on a base having a screw thread. In order to screw the base into a mounting provided for the purpose the mechanism is brought into the second state such that the illumination means are connected to the base in a rotatably fixed manner. The lamp can then be gripped by the mechanism or by the illumination means and the base can be screwed into the mounting.

If the mechanism is subsequently brought into the first state, the illumination means can be rotated with respect to the screwed-in base. The illumination means can therefore be rotated and the illumination cone of the lamp can thus be orientated in a space without the base being unscrewed from the mounting again.

Provision can also be made such that the mechanism cannot be turned if no external force is exerted by a user and only by pushing or pulling is it made possible to turn the illumination means independently of the base.

A lamp according to the invention, as it has just been described, is thus preferably to be operated with the following steps:
a) provision of a mounting;
b) connection of the base of the lamp to the mounting, whereby the lamp is in the second state;
c1) changing the state of the lamp to the first state;
c2) rotating the illumination means.

In this situation, the lamp is particularly advantageously designed if it is equipped with a base in accordance with the E24 or E26 or E27 or E14 or GU10 or GU5.5 standard. Conventional light fittings are normally equipped with a mounting for one of these sockets. A lamp according to the invention having a base in accordance with one of the aforementioned standards can thus be used in light fittings without there being a need to structurally modify the light fittings.

A further solution given by the invention results for lamps in accordance with the preamble of claim 4. It thus relates to a lamp, the base of which has a thread, whereby a first contact element for making the electrical connection between an illumination means and a contact point on a mounting is arranged on the base in a region other than the thread. In a development according to the invention of such a lamp, the first contact element is spring-mounted on the base or is itself a spring. Moreover, light emitted by the illumination means has an intensity distribution which is asymmetric with respect to an axis of the thread. This embodiment of the lamp according to the invention can be designed in such a manner that it can be screwed into mountings for conventional filament lamps. With regard to the lamp according to the invention, the light beam emitted by the LED lamp can in this situation be orientated in a simple manner. Because the first contact element is spring-mounted on the base or is itself a spring, the lamp can be rotated back and forth in its mounting without any interruption occurring in this situation in the contact with a contact point on the mounting. By contrast, such an interruption would happen in the case of a lamp according to the prior art. In other words, with regard to this lamp according to the invention, the thread of the mounting is used at the same time as a screw thread for orientating the illumination cone of the lamp.

The spring stroke by which a touching point of the first contact element with the contact point can be moved in relation to the base is preferably chosen to be of such a length that the base can be rotated once completely in a mounting, that is to say by 360°, without the electrical contact between the first contact element and the contact point on the mounting being interrupted in this situation.

With regard to the lamp according to the invention having the spring-mounted contact elements, the intensity distribution of the emitted light is not rotationally symmetrical with respect to the axis of the thread because otherwise no change in the emission characteristic with respect to the mounting of the light fitting would be achievable by means of rotating the lamp in the mounting.

In an advantageous manner, with regard to the lamp according to the invention just described, arranged on the thread itself is a second contact element which is spring-mounted on the base or is itself a spring. Such a further springy contact element can for example be a springy or flexible wire or also a sliding contact. This second springy contact element exerts a force at right angles to the axis of the thread on the base when the latter is screwed into a mounting. This means that the base is then also seated tightly in the mounting if the lamp is screwed a little way out of the mounting in order to pivot the illumination cone.

The lamp according to the invention having a screw thread is preferably equipped with a base in accordance with the E24 or E26 or E27 or E14 standard. The lamp according to the invention can thus be used in conventional light fittings.

A further aspect of the invention relates to a mounting for a lamp having pin contacts. With regard to this mounting, a first body is used for coupling the lamp with the mounting by means of the pin contacts. A second body of the mounting is used for securing the mounting on a light fitting. The first body is rotatably connected to the second body. By means of such a mounting it is therefore possible to insert a lamp having pin contacts into the mounting and subsequently by rotating the first body with respect to the second body to set an emission characteristic relating to the emitted light, in other words an orientation of the illumination cone of the lamp in the space.

Such a mounting according to the invention has the advantage that it can be installed in commercially available light fittings and such light fittings thus enable the flexible usage of LED lamps in a cost-effective manner.

All the described lamps according to the invention are based on the knowledge that by providing a capability for rotating at least one part of a lamp in a conventional light fitting the advantage can be achieved that LED lamps having a focused emission characteristic also make possible a flexible illumination of an area surrounding the light fitting.

A method having the following steps for operating a lamp can thus be carried out with regard to all embodiments of devices:
a) provision of a mounting;
b) connection of a base of the lamp to the mounting;
c) adjustment of a directional characteristic with respect to the emitted light by rotating at least one part of the lamp with respect to at least one part of the mounting.

As a part of the lamp is capable of rotation relative to a part of the mounting, a light beam emitted by the lamp can be pivoted without any structural modification of the light fitting into which the mounting is installed. Adjusting the directional characteristic with respect to the emitted light here means pivoting the illumination cone of the lamp in the space or, in other words, adjusting the emission characteristic of the light fitting. In this situation, this directional characteristic or emission characteristic is related to the light fitting. It thus results from the directional characteristic of the lamp itself and the spatial orientation of the lamp in the space, as determined by the orientation of the mounting.

### BRIEF DESCRIPTION OF THE DRAWINGS

The invention will be described in detail in the following with reference to exemplary embodiments. In the drawings:

FIG. 1 shows an embodiment of a lamp according to the invention, wherein illumination means and a base can be rotated against each other;

FIG. 2 shows a further embodiment of a lamp according to the invention, wherein illumination means can be both rotated and also pivoted with respect to a base;

FIG. 3 shows an embodiment of a lamp according to the invention, wherein a base has spring-mounted contact elements; and

FIG. 4 shows an embodiment of a mounting according to the invention for a lamp.

### PREFERRED EMBODIMENT OF THE INVENTION

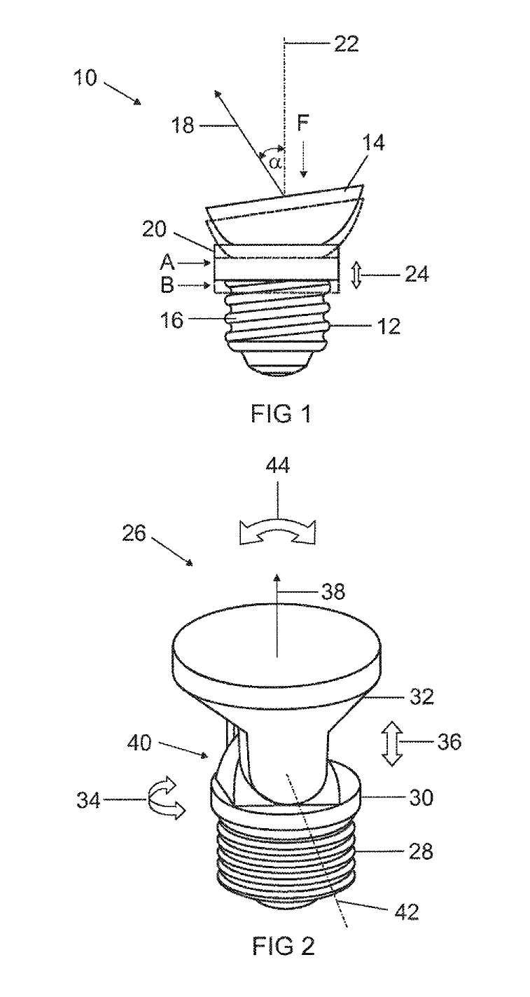

The lamp 10 shown in FIG. 1 has a screw base 12 which is connected to a reflector 14. The thread 16 of the base 12 is simply suggested in FIG. 1. In the reflector 14, a plurality of light emitting diodes (LEDs) is arranged on a printed circuit board, whereby all the LEDs are orientated in one direction. The printed circuit board with the LEDs cannot be seen in FIG. 1. The LEDs all point in one direction 18 in accordance with their orientation in the reflector 14. In this situation, an intensity distribution of the emitted light ascertained at a constant distance around the lamp 10 exhibits a rotational symmetry around an axis predetermined by the direction 18. In other words, the illumination cone of the lamp 10 has the form of a mathematical cone. In this situation, the greatest intensity is produced in direction 18, in other words the axis of symmetry of the cone.

The reflector 14 with the LEDs arranged therein is arranged on a mechanism 20 which can be brought into a first position A and a second position B with respect to the base 12. In this situation, a spring mechanism in the interior of the base 12 holds the mechanism 20 in the position A if no further force is exerted on the reflector 14 or the mechanism 20 by a user. When the mechanism 20 is in the position A, the mechanism 20 with the reflector 14 arranged thereon and the LEDs arranged therein can be rotated around an axis 22 in relation to the base 12. Therefore when the base 12 is screwed into a mounting of a light fitting, the reflector 14 can be rotated around the axis 22 without the base 12 becoming unscrewed from the mounting in the process. Thus, by rotating the reflector 14 around the axis 22 a user can pivot the direction 18 in which the LEDs of the lamp 10 emit with the greatest intensity, namely in relation to a light fitting into which the lamp 10 is screwed. In other words, the lamp 10 has an illumination cone which can be orientated in a space by rotating the reflector 14 around the axis 22. This is made possible by the fact that the direction 18 encloses an angle α with the axis 22, whereby the angle α is not equal to 0°. The direction vectors of all the possible directions 18 in this situation thus lie on a lateral surface of an imaginary cone, the axis of which is identical to the axis of rotation 22 and the beam angle of which is twice the angle α.

If a user pushes with a force F on the reflector 14, the spring mechanism in the interior of the base 12 relaxes and the reflector 14 and the mechanism 20 move along an axis which is indicated by the double arrow 24 into a position B. In FIG. 1, dashed lines show the position in which the mechanism 20 and the reflector 14 are situated according to position B.

In position B, teeth in the interior of the mechanism 20 engage in corresponding teeth in the interior of the base 12. By this means, a rotational movement of the mechanism 20 and the reflector 14 around the axis of rotation 22 is blocked. If a user now turns the reflector 14 the base 12 is also turned, which means that the lamp 10 can be screwed out from a mounting or screwed into a mounting.

The lamp 26 shown in FIG. 2 is a development of the lamp shown in FIG. 1. The lamp 26 likewise has a base 28 having a screw thread. On the base 28 is mounted a mechanism 30 which carries a reflector 32. The mechanism 30 is arranged on the base 28 to be capable of rotation around an axis of rotation together with the reflector 32. The possible directions of the rotational movement are indicated by an arrow 34. By pushing the reflector 32 in the direction of the base 28, the mechanism 30 can be fixed in relation to the base 28 in such a manner that the rotation in the manner described above for the lamp from FIG. 1 is blocked. By pushing and releasing the reflector 32 or the mechanism 30, the two parts thereby move along a longitudinal axis of the base 28, as is illustrated by a double arrow 36 in FIG. 2.

In the reflector 32, LEDs all point in a preferred direction 38. The LEDs are not illustrated in FIG. 2. In contrast to the lamp shown in FIG. 1, the lamp 26 has a swivel mechanism 40, by means of which the reflector 32 and the LEDs arranged therein can be pivoted around a swivel axis 42 in relation to the mechanism 30. With regard to the rotational position of the mechanism 30 with respect to the base 28 shown in FIG. 2, swivel movements are possible in this situation, as are indicated by the double arrow 44. An illumination cone of the lamp 26, in other words an emission characteristic of a light fitting into which the lamp 26 is screwed can thus be adjusted particularly flexibly by rotating the mechanism 30 and by swiveling the reflector 32 around the axis 42. With regard to the orientation of the reflector 32 with respect to the base 28 illustrated in FIG. 2, it is however not possible to pivot the illumination cone by rotating the mechanism 30 because the illumination cone is orientated symmetrically to the axis of rotation of the mechanism 30. This is however a special case of adjustment of the swivel mechanism 40. In all other swivel positions of the swivel mechanism 40 the illumination cone is orientated asymmetrically to the axis of rotation of the mechanism 30.

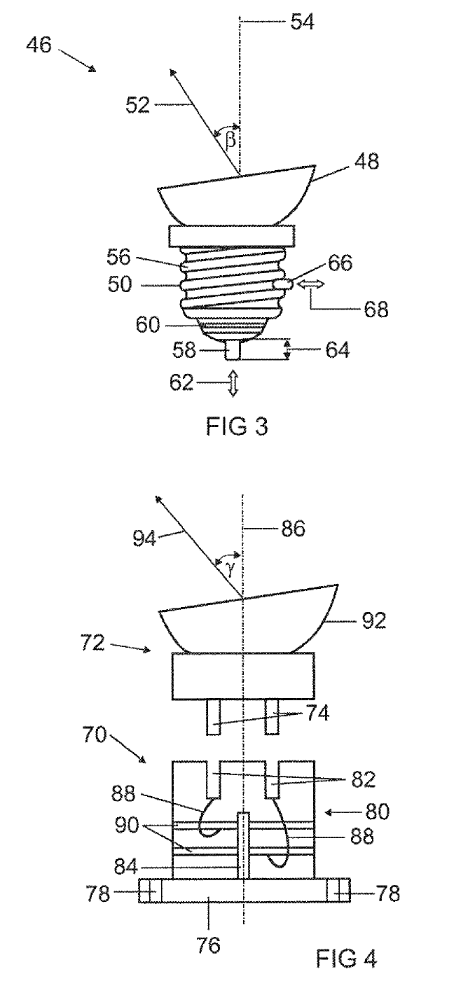

In FIG. 3 a lamp 46 is shown wherein a reflector 48 is rigidly connected to a screw base 50 in accordance with the E24 standard. LEDs arranged in the reflector 48 are all orientated in a preferred direction 52, the direction vector of which encloses an angle β with an axis 54 of a thread 56 of the base 50. The thread 56 is only suggested in the illustration in FIG. 3.

In accordance with the E24 standard, the base 50 has at its foot a contact element 58 which is electrically insulated from the thread 56 by means of an insulator 60. In contrast to a base from the prior art, with regard to the base 50 however the contact element 58 is spring-mounted on the base, such that the contact element 58 can be pushed along a spring stroke 62 into the base 50. A user can thereby screw the lamp 46 with the base 50 into a corresponding mounting and when the lamp 46 is almost completely screwed in rotate it back and forth without the voltage supply to the lamp 46 being interrupted in the process. That is to say, if the base 50 is screwed in and out progressively in the mounting on account of the turning back and forth, the contact element 58 compensates for a change in position of the base 50 inside the mounting and maintains an electrical contact with a contact point on the mounting. The overall length 64 of the spring stroke 62 of the contact element 58 in this situation is chosen as a function of a helix angle of the thread 56 such that it is possible, if base 50 has at one time been screwed completely into a mounting, to screw it one full revolution out of the mounting again before the contact element 58 loses contact with the corresponding contact point on the mounting.

Even if the base 50 is screwed one full revolution out of the mounting, it is nevertheless securely seated in the mounting. This is ensured by a springy wire 66 which is arranged in a recess in the base 50 in the region of the thread 56. The wire 66 can execute a springy movement in directions which are indicated by the double arrow 68. If the lamp 46 is screwed into a mounting, the springy wire 66 exerts a force on the base at right angles to the axis 54 of the thread. In this situation, the wire 66 can be pushed into the recess to such an extent that the base 50 can be screwed into and out of a corresponding thread of a mounting.

With the mounting 70 shown in FIG. 4, it is possible to hold a lamp 72 having pin contacts 74 and supply it with electrical voltage. In this situation, the mounting 70 is designed in two parts. A first part 76 has two drilled holes 78 for screws, not shown in FIG. 4, by means of which the mounting 70 is screwed in place in a light fitting not illustrated in FIG. 4. A plug-in part 80 has two female connectors 82 into which the pin contacts 74 of the lamp 72 can be inserted. The plug-in part 80 is connected to the part 76 by way of a rotating mechanism 84, such that the plug-in part 80 can be rotated around an axis 86 with respect to the part 76. The female connectors 82 are connected by way of flexible wires 88 to contacts 90 in the screwed-in part 76. A stop not shown in FIG. 4 prevents the plug-in part 80 from being turned so far that the flexible wires 88 break.

The lamp 72 shown in FIG. 4 has a reflector 92 in which LEDs not shown in FIG. 4 are arranged orientated in a common direction 94. When the lamp 72 is inserted into the plug-in part 80 of the mounting 70, the LEDs are orientated at an angle γ to the axis of rotation 86 of the plug-in part 80. By turning the lamp 72 around the axis 86 it is thus possible to determine the spatial direction in which the LEDs primarily emit their light.

The examples illustrate how the invention makes it possible to use LED lamps in conventional light fittings and in this situation to flexibly adjust the emission characteristic of the arrangement comprising light fitting and lamp.

1. A lamp, comprising:
illumination means which comprise at least one light emitting diode; and
a base, by way of which the lamp can be connected to a mounting in order to be supplied with voltage,
wherein
the illumination means are connected to the base by way of a mechanism which in a first state couples the illumination means in rotatable fashion to the base around an axis and in a second state couples the illumination means to the base in a rotatably fixed manner, and
light emitted by the illumination means has an intensity distribution which is asymmetric with respect to the axis.

2. The lamp as claimed in claim 1, wherein the mechanism can be transferred from the one state into the other state by pushing or pulling a part of the mechanism.

3. The lamp as claimed in claim 1, further comprising:
a base in accordance a standard selected from a group consisting of:
the E24 standard;
the E26 standard;
the E27 standard;
the E14 standard;
the GU 10 standard; and
the GU 5.3 standard,

4. A lamp, comprising:
illumination means which comprise at least one light emitting diode, and
a base, by way of which the lamp can be connected to a mounting in order to be supplied with voltage, wherein
the base has a thread and
a contact element configured to make the electrical connection between the illumination means and a contact point on the mounting is arranged on the base in a region other than the thread,
wherein
the contact element is spring-mounted on the base or is itself a spring and
light emitted by the illumination means has an intensity distribution which is asymmetric with respect to an axis of the thread.

5. The lamp as claimed in claim 4, wherein arranged on the base in the region of the thread is a further contact element which is spring-mounted on the base or is itself a spring.

6. The lamp as claimed in claim 4, further comprising:
a base in accordance with a standard selected from a group consisting of:
the E24 standard;
the E26 standard;
the E27 standard; and
the E14 standard.

7. A mounting for a lamp having pin contacts (74), the mounting comprising:
a first body for coupling the lamp by means of the pin contacts; and
second body for securing the mounting on a light fitting, wherein the first body is rotatably connected to the second body.

8. A method for operating a lamp, the method comprising:
a) providing a mounting;
b) connecting a base of the lamp to the mounting;
e) adjusting a directional characteristic with respect to the emitted light by rotating at least one part of the lamp with respect to at least one part of the mounting.

9. The method as claimed in claim 8 for operating a lamp, the lamp comprising:
illumination means which comprise at least one light emitting diode; and
a base, by way of which the lamp can be connected to a mounting in order to be supplied with voltage,
wherein the illumination means are connected to the base by way of a mechanism which in a first state couples the illumination means in rotatable fashion to the base around an axis and in a second state couples the illumination means to the base in a rotatably fixed manner, and
wherein light emitted by the illumination means has an intensity distribution which is asymmetric with respect to the axis;
wherein b), connection, and c), adjustment, comprise:
b11) connecting the base of the lamp to the mounting, wherein the lamp is in the second state;
c11) changing the state of the lamp to the first state;
c12) rotating the illumination means.

10. The method as claimed in claim 8 for operating a lamp, the lamp comprising:
illumination means which comprise at least one light emitting diode, and comprising
a base, by way of which the lamp can be connected to a mounting in order to be supplied with voltage, wherein
the base has a thread and
a contact element configured to make the electrical connection between the illumination means and a contact point on the mounting is arranged on the base in a region other than the thread,
wherein the contact element is spring-mounted on the base or is itself a spring and
light emitted by the illumination means has an intensity distribution which is asymmetric with respect to an axis of the thread;
wherein b), connection, and c), adjustment, comprise:
b21) screwing the base into the mounting at least sufficiently far for the first contact element to become electrically connected to the contact point on the mounting;
c21) rotating the lamp in the mounting, wherein the first contact element remains electrically connected to the contact point.

11. The method as claimed in claim 8 for operating a lamp having pin contacts,
wherein a), provision, and c), adjustment, comprise:
a1) providing a mounting as claimed in claim 7;
c31) rotating the first body with respect to the second body.
